(19) United States
(12) Patent Application Publication
(10) Pub. No.: US 2003/0112821 A1
(43) Pub. Date: Jun. 19, 2003

(54) System and method for increasing a data transmission rate in mobile wireless communication channels

(75) Inventors: Joseph Robert Cleveland, Richardson, TX (US); Jae Doeg Lim, Allen, TX (US); William Joseph Semper, Richardson, TX (US)

Correspondence Address: Docket Clerk, P.O. Drawer 800889, Dallas, TX, 75380, US

(73) Assignee: SAMSUNG ELECTRONICS Co., LTD., Suwon-city (KR)

(21) Appl. No.: 10/024,687

(22) Filed: Dec. 14, 2001

(51) Int. Cl. H04J 3/24

(52) U.S. Cl. 370/468; 370/345

(57) ABSTRACT

A system and method is disclosed for increasing a data transmission rate in mobile wireless communication channels. The invention comprises a base station that is capable of sending data packets to a mobile station at a first data rate and then sending replacement data packets to the mobile station at a second higher data rate to replace missing or error data packets. The mobile station comprises a replacement data packet controller that replaces missing or error data packets with replacement data packets. During a handoff of the mobile station a first base station sends an A3 physical transition directive message to a second base station to increase bandwidth on a supplemental channel for sending replacement data packets to the mobile station. The bandwidth is decreased after the mobile station receives the replacement data packets.

### TECHNICAL FIELD OF THE INVENTION

The present invention is directed, in general, to wireless communication devices and, more specifically, to a system and method for increasing a data transmission rate in mobile wireless communication channels.

### BACKGROUND OF THE INVENTION

Wireless communication systems, including cellular phones, paging devices, personal communication services (PCS) systems, and wireless data networks, have become ubiquitous in society. Wireless service providers continually try to create new markets for wireless devices and to expand existing markets by making wireless devices and services cheaper and more reliable. The price of end-user wireless devices, such as cell phones, pagers, PCS systems, and wireless modems, has been driven down to the point where these devices are affordable to nearly everyone and the price of a wireless device is only a small part of the end-user's total cost. To continue to attract new customers, wireless service providers concentrate on reducing infrastructure costs and operating costs, and on increasing handset battery lifetime, while improving quality of service in order to make wireless services cheaper and better.

To maximize usage of the available bandwidth, a number of multiple access technologies have been implemented to allow more than one subscriber to communicate simultaneously with each base station (BS) in a wireless system. These multiple access technologies include time division multiple access (TDMA), frequency division multiple access (FDMA), and code division multiple access (CDMA). These technologies assign each system subscriber to a specific traffic channel that transmits and receives subscriber voice/data signals via a selected time slot, a selected frequency, a selected unique code, or a combination thereof.

CDMA technology is used in wireless computer networks, paging (or wireless messaging) systems, and cellular telephony. In a CDMA system, mobile stations and other access terminals (e.g., pagers, cell phones, laptop PCs with wireless modems) and base stations transmit and receive data on the same frequency in assigned channels that correspond to specific unique orthogonal codes. For example, a mobile station may receive forward channel data signals from a base station that are encoded, formatted, interleaved, spread with a Walsh code and a long pseudo-noise (PN) sequence. In another example, a base station may receive reverse channel data signals from the mobile station that are encoded, block interleaved, modulated with 64-ary encoding (or, alternatively, with BPSK or QPSK), and spread with a spreading code derived from the mobile station identification number prior to transmission by the mobile station. The data symbols following interleaving may be separated into an in-phase (I) data stream and a quadrature (Q) data stream for QPSK modulation of an RF carrier. One such implementation is found in the TIA/EIA-95 CDMA standard (also known as IS-95). Another implementation is the TIA/EIA-2000 standard (also known as IS-2000).

The current generation of cellular phones is used primarily for voice conversations between a subscriber device (or wireless device) and another party through the wireless network. A smaller number of wireless devices are data devices, such as personal digital assistants (PDAs) equipped with cellular/wireless modems. Because the bandwidth for a current generation wireless device is typically limited to a few tens of kilobits per second (Kbps), the applications for the current generation of wireless devices are relatively limited. However, this is expected to change in the next (or third) generation of cellular/wireless technology, sometimes referred to as “3G” wireless/cellular, where much greater bandwidth will be available to each wireless device (i.e., one hundred fifty three and six tenths kilobits per second (153.6 kbps) or greater). The higher data rates will make Internet applications for wireless devices much more common. For instance, a 3G cell phone (or a PC with a 3G cellular modem) may be used to browse web sites on the Internet, to transmit and receive graphics, to execute streaming audio or video applications, and the like. A much higher percentage of the wireless traffic handled by 3G cellular systems will be Internet protocol (IP) traffic and a lesser percentage will be traditional voice traffic.

Real-time streaming of multimedia content over Internet protocol (IP) networks has become an increasingly common application in recent years. As noted above, 3G wireless networks will provide streaming data (both video and audio) to wireless devices for real time applications. A wide range of interactive and non-interactive multimedia Internet applications, such as news on-demand, live TV viewing, video conferencing, live radio broadcasting (such as Broadcast.com), and the like, will provide “real time” data streaming to wireless devices. Unlike a “downloaded” video file, which may be retrieved first in “non-real” time and viewed or played back later, real time (or streaming) data applications require a data source to encode and to transmit a streaming data signal over a network to a receiver, which must decode and play the signal (video or audio) in real time.

As is well known in the art, when a mobile station receives forward channel Internet protocol data packets from a base station the mobile station acknowledges receipt of the data packets by sending to the base station an acknowledgment signal (referred to as an ACK signal). If the channel is subject to fading the mobile station may not receive some of the data packets during a fade. If the mobile station determines that it has failed to receive some of the data packets or that there are errors in some of the received data packets, the mobile station acknowledges this condition by sending to the base station a negative acknowledgment signal (referred to as a NACK signal). ACK signals and NACK signals may be sent through a Dedicated Control Channel (DCCH).

For example, the mobile station may inform the base station that in the most recent transmission the mobile station failed to receive packet numbers thirteen (13) through sixteen (16) and that packet numbers twenty six (26) through twenty nine (29) contained errors. The mobile station does this by sending to the base station a NACK signal for the packets thirteen (13) through sixteen (16) and a NACK signal for the packets twenty-six (26) through twenty-nine (29).

The base station may remedy the failure of the mobile station to correctly receive all of the data packets by re-transmitting the missing or error data packets. However, such re-transmission takes additional time and results in a delay in the transmission of a complete version of the data. For time sensitive data (such as voice data or video data) a delay caused by re-transmission of missing or error data packets may result in a loss of data. This is because data packets that arrive after a specific time window are discarded.

Therefore, there is a need in the art for a system and method that is capable of providing to a mobile station in a timely manner replacement data packets for missing or error data packets. In particular, there is a need for a system and method that is capable of providing to a mobile station replacement data packets for missing or error data packets so that there is no substantial delay in the arrival of the replacement data packets at the mobile station. More particularly, there is a need for a system and method that is capable of increasing a data transmission rate to transmit to a mobile station replacement data packets for missing or error data packets so that there is no substantial delay in the arrival of the replacement data packets at the mobile station.

### SUMMARY OF THE INVENTION

It is an object of the present invention to provide a system and method that is capable of increasing a data transmission rate in a wireless communications channel to transmit to a mobile station replacement data packets for missing or error data packets.

The system and method of the invention comprises a base station that is capable of sending data packets to a mobile station at a first data rate. If the mobile station fails to receive data packets or receives error data packets, the mobile station sends a negative acknowledgment message to the base station. In response the base station then sends replacement data packets to the mobile station at a second higher data rate to replace missing or error data packets. The replacement data packets may be sent on a supplemental channel while base station is sending normally scheduled data packets on a fundamental channel. Alternatively, if the normally scheduled data packets are being sent on a supplemental channel, the base station may temporarily increase the bandwidth on the supplemental channel during the time that the replacement data packets are being sent.

The mobile station of the present invention comprises a replacement data packet controller that replaces missing or error data packets with replacement data packets. The replacement data packet controller receives replacement data packets from the base station and incorporates them into a data packet stream before the data packet stream is presented to the end user.

In an alternate advantageous embodiment of the invention, a first base station is handing off a mobile station to a second base station. The first base station is sending data packets to the second base station on a backhaul network that connects the set of base station controllers that comprise the base station system in the wireless network. The second base station is sending the data packets to the mobile station on a supplemental channel at a first data rate. To send replacement data packets at a higher second data rate the first base station sends an A3 physical transition directive message to the second base station to cause the second base station to increase the bandwidth of the supplemental channel. The first base station then sends the replacement data packets to the second base station and the second base station sends the replacement data packet to the mobile station on the increased bandwidth supplemental channel at the higher second data rate. After the mobile station has acknowledged receipt of the replacement data packets, the first base station sends another A3 physical transition directive message to the second base station to cause the second base station to decrease the bandwidth on the supplemental channel. The first base station and the second base station then send data packets to the mobile station on the supplemental channel at the first data rate.

It is an object of the present invention to reduce the time required for the transmission of data packets in a communication channel that experiences fading.

It is also an object of the present invention to improves the reliability of the communication of time sensitive information transmitted by data packets.

It is another object of the present invention to efficiently use of available bandwidth in a multi-channel system.

It is yet another object of the present invention to reduce the transmit power required by transmitters to produce a reliable transmission of data packets.

It is an additional object of the present invention to reduce the amount of battery power required in a mobile station in a mobile wireless communication system.

It is also an object of the present invention to provide an increased level of quality of service in wireless communication channels.

It is another object of the present invention to increase the efficiency of spectrum utilization in code division multiple access (CDMA) wireless communication systems.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary prior art wireless network;

FIG. 2 illustrates an exemplary base station according to an advantageous embodiment of the present invention;

FIG. 3 illustrates an exemplary wireless mobile station according to an advantageous embodiment of the present invention;

FIG. 4 illustrates a flow chart showing the steps of a first advantageous embodiment of the method of the present invention;

FIG. 5 illustrates a flow chart showing the steps of a second advantageous embodiment of the method of the present invention;

FIG. 6 illustrates an exemplary handoff of a wireless mobile station according to an advantageous embodiment of the present invention;

FIG. 7 illustrates a format for a physical transition directive message of the present invention; and

FIG. 8 illustrates a flow chart showing the steps of an exemplary handoff of a wireless mobile station according to an advantageous embodiment of the method of the present invention.

### DETAILED DESCRIPTION OF THE INVENTION

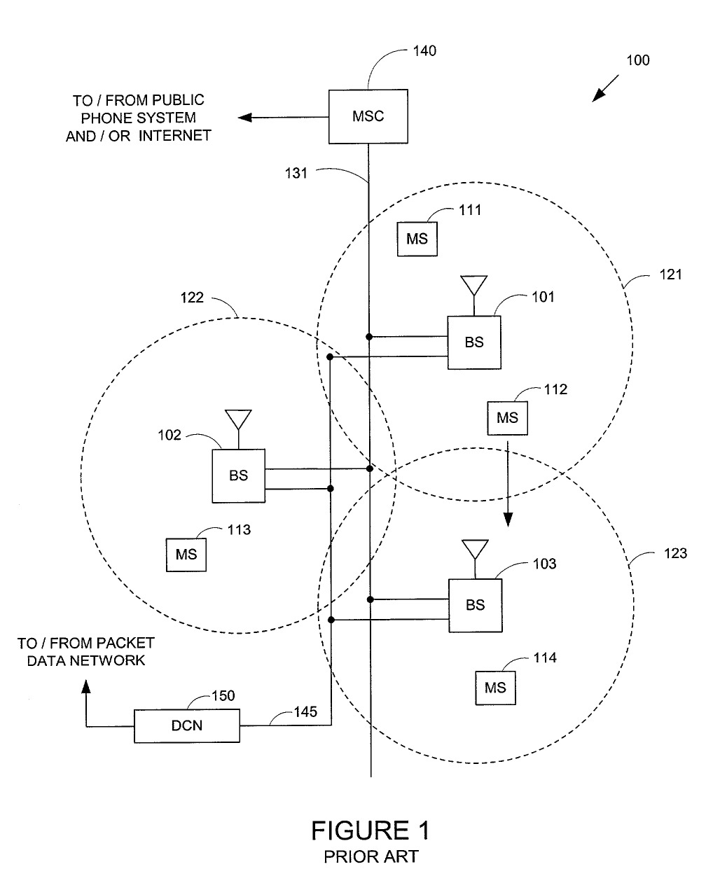

FIGS. 1 through 8, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless mobile communications network.

FIG. 1 illustrates an exemplary prior art wireless network 100. Wireless network 100 comprises a plurality of cell sites 121-123, each containing one of the base stations, BS 101, BS 102, or BS 103. Base stations 101-103 are operable to communicate with a plurality of mobile stations (MS) 111-114. Mobile stations 111-114 may be any suitable wireless communication devices, including conventional cellular telephones, PCS handset devices, portable computers, telemetry devices, and the like, which are capable of communicating with the base stations via wireless links. Other types of access terminals, including fixed access terminals, also may be present in wireless network 100. However, for the sake of simplicity, only mobile stations are shown.

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

Each of the base stations BS 101, BS 102, and BS 103 may comprise a base station controller (BSC) and a base transceiver station (BTS). Base station controllers and base transceiver stations are well known to those skilled in the art. A base station controller is a device that manages wireless communications resources, including the base transceiver station, for specified cells within a wireless communications network. A base transceiver station comprises the RF transceivers, antennas, and other electrical equipment located in each cell site. This equipment may include air conditioning units, heating units, electrical supplies, telephone line interfaces, and RF transmitters and RF receivers. For the purpose of simplicity and clarity in explaining the operation of the present invention, the base transceiver station in each of cells 121, 122, and 123 and the base station controller associated with each base transceiver station are collectively represented by BS 101, BS 102 and BS 103, respectively.

BS 101, BS 102 and BS 103 transfer voice and data signals between each other and the public telephone system (not shown) via communications line 131 and mobile switching center (MSC) 140. Mobile switching center 140 is well known to those skilled in the art. Mobile switching center 140 is a switching device that provides services and coordination between the subscribers in a wireless network and external networks, such as the public telephone system and/or the Internet. Communications line 131 links each vocoder in the base station controller (BSC) with switch elements in the mobile switching center (MSC) 140. In one advantageous embodiment, each link provides a digital path for transmission of voice signals in the pulse code modulated (PCM) format. Communications line 131 may be any suitable connection means, including a T1 line, a T3 line, a fiber optic link, a network backbone connection, and the like. In some embodiments, communications line 131 may be several different data links, where each data link couples one of BS 101, BS 102, or BS 103 to MSC 140.

BS 101, BS 102 and BS 103 transfer data signals between each other and the Internet or other packet data network (not shown) via communications line 145 and data core network (DCN) server 150. Data core network (DCN) server 150 is well known to those skilled in the art. Data core network (DCN) server 150 is a packet data switching or routing device that provides services and coordination between the subscribers in a wireless network and external packet data networks, such as a corporate Ethernet system and/or the Internet. Those skilled in the art will understand that line 145 interfaces to a packet data serving node (not shown) located in data core network 150. Communications line 145 may be any suitable connection line, including an Ethernet link, a T1 connection, a T3 line, a fiber optic link, a network backbone connection, and the like. In some embodiments, communications line 145 may comprise several different data links, where each data link couples one of BS 101, BS 102, or BS 103 to data core network (DCN) 150.

In the exemplary wireless network 100, MS 111 is located in cell site 121 and is in communication with BS 101, MS 113 is located in cell site 122 and is in communication with BS 102, and MS 114 is located in cell site 123 and is in communication with BS 103. The MS 112 is also located in cell site 121, close to the edge of cell site 123. The direction arrow proximate MS 112 indicates the movement of MS 112 towards cell site 123. At some point, as MS 112 moves into cell site 123 and out of cell site 121, a handoff will occur.

As is well known to those skilled in the art, the handoff procedure transfers control of a call from a first cell to a second cell. A handoff may be either a “soft handoff” or a “hard handoff.” In a “soft handoff” a connection is made between the mobile station and the base station in the second cell before the existing connection is broken between the mobile station and the base station in the first cell. In a “hard handoff” the existing connection between the mobile station and the base station in the first cell is broken before a new connection is made between the mobile station and the base station in the second cell.

For example, assume that mobile stations 111-114 communicate with base stations BS 101, BS 102 and BS 103 over code division multiple access (CDMA) channels. As MS 112 moves from cell 121 to cell 123, MS 112 determines that a handoff is required based on detection of a pilot signal from BS 103, increased bit error rate on signals from BS 101, signal round trip delay time between BS 101 and MS 112, or some other characteristic. When the strength of the control signal transmitted by BS 103, or the bit error rate of signals received from BS 101, or the round trip time delay exceeds a threshold, BS 101 initiates a handoff process by signaling MS 112 and the target BS 103 that a handoff is required. In one advantageous embodiment, MS 112 sends a Pilot Strength Measurement Message (PSMM) to BS 101, which contains pilot strength data for BS 103. When the strength of the pilot transmitted by BS 103 and received and reported by MS 112 exceeds a threshold, BS 101 initiates a soft handoff process by signaling the target base station BS 103 that a handoff is required as described in TIA/EIA IS-95 or TIA/EIA IS-2000. BS 103 and MS 112 proceed to negotiate establishment of a communications link. The call is thereby transferred from BS 101 to BS 103. An idle handoff is a handoff between cells of a mobile device that is communicating in the control or paging channel, rather than transmitting voice and/or data signals in the regular traffic channels.

One or more of the wireless devices in wireless network 100 may be capable of executing real time applications, such as streaming audio or streaming video applications. Wireless network 100 receives the real time data from, for example, the Internet through data core network (DCN) server 150 and through communications line 145 and transmits the real time data in the forward channel to the wireless device. For example, MS 112 may comprise a 3G cellular phone device that is capable of surfing the Internet and listening to streaming audio, such as music from the web site “www.mp3.com” or a sports radio broadcast from the web site “www.broadcast.com.” MS 112 may also view streaming video from a news web site, such as “www.CNN.com.” To avoid increasing the memory requirements and the size of wireless phone devices, one or more of the base stations in wireless network 100 provide real time data buffers that can be used to buffer real time data being sent to, for example, MS 112.

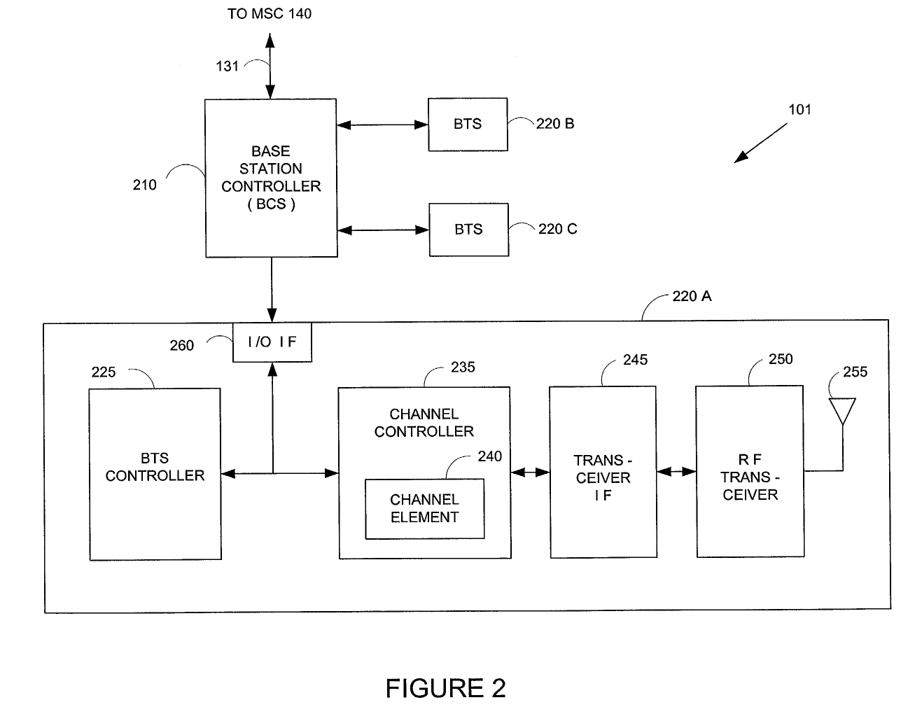

FIG. 2 illustrates base transceiver station (BTS) 220A in exemplary base station 101 in greater detail according to an advantageous embodiment of the present invention. Base station 101 comprises base station controller (BSC) 210 and BTS 220A, 220B, and 220C. Base station controllers and base transceiver stations were described previously in connection with FIG. 1.

BSC 210 manages the resources in cell site 121, including BTS 220A, BTS 220B, and BTS 220C. As described above, BSC 210 is coupled to MSC 140 over data communication line 131. Exemplary BTS 220A comprises BTS controller 225, channel controller 235 that contains channel element 240, transceiver interface (IF) 245, RF transceiver unit 250, and antenna array 255. Input/output interface (I/O IF) 260 couples BTS 220A to BSC 210.

BTS controller 225 controls the overall operation of BTS 220A and interfaces with BSC 210 through I/O IF 260. BTS controller 225 directs the operation of channel controller 235. Channel controller 235 contains a number of channel elements such as channel element 240. The channel elements perform bi-directional communications in the forward and reverse links. Depending on the air interface used by system BS 101, the channel elements engage in time division multiple access (TDMA), frequency division multiple access (FDMA), or code division multiple access (CDMA) communications with the mobile stations in cell 121.

Transceiver IF 245 transfers the bi-directional channel signals between channel controller 235 and RF transceiver 250. Transceiver IF 245 converts the radio frequency signal from RF transceiver 250 to an intermediate frequency (IF). Channel controller 235 then converts this intermediate frequency (IF) to baseband frequency. Additionally, RF transceiver 250 may contain an antenna selection unit to select among different antennas in antenna array 255 during both transmit and receive operations.

Antenna array 255 is comprised of a number of directional antennas that transmit forward link signals, received from RF transceiver 250, to mobile stations in the sectors covered by BS 101. Antenna array 255 also receives reverse link signals from the mobile stations and sends the signals to RF transceiver 250. In a preferred embodiment of the present invention, antenna array 255 is a multi-sector antenna, such as a six-sector antenna, in which each antenna is responsible for transmitting and receiving in a sixty degree (60°) arc of coverage area.

BS 101 of the present invention is not limited to the architecture described above. The architecture may be different depending on the type of air interface standard used by the wireless system. Additionally, the present invention is not limited by the frequencies used. Different air interface standards require different frequencies.

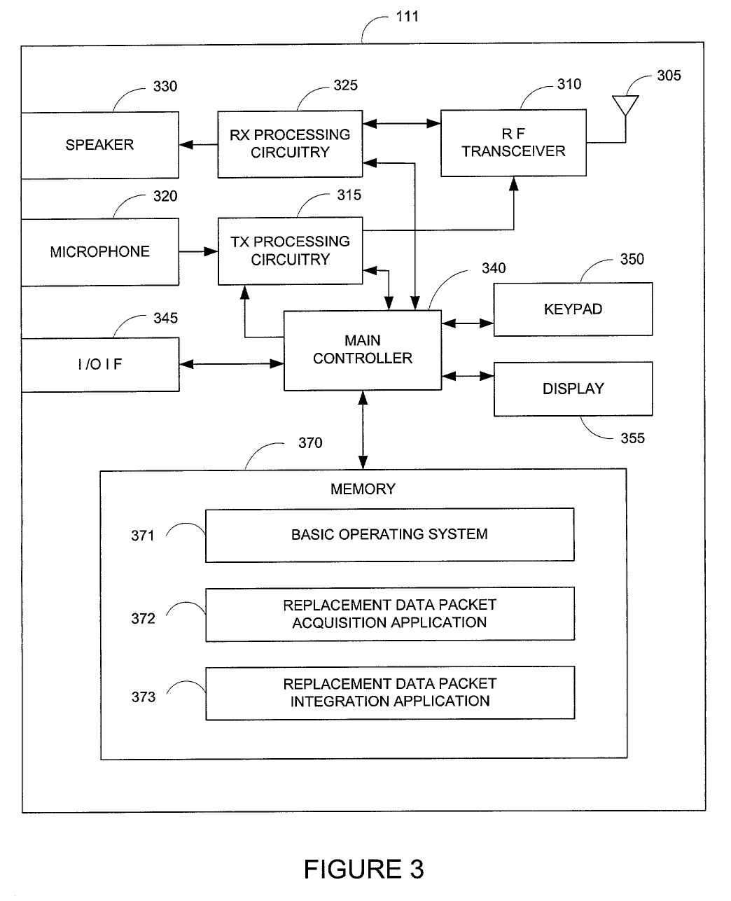

FIG. 3 illustrates exemplary wireless mobile station 111 in greater detail according to an advantageous embodiment of the present invention. Wireless mobile station 111 comprises antenna 305, radio frequency (RF) transceiver 310, transmitter (TX) processing circuitry 315, microphone 320, receiver (RX) processor circuitry 325, speaker 330, main controller 340, input/output (I/O) interface (IF) 345, keypad 350, and display 355.

Wireless mobile station 111 further comprises memory 370, that stores basic operating system (OS) program 371, replacement data packet acquisition application 372, and replacement data packet integration application 373. Wireless mobile station 111 may be a cellular telephone, a personal digital assistant (PDA) device equipped with a wireless modem, a two-way pager, a personal communication system (PCS) device, or any other conventional wireless mobile system device.

RF transceiver 310 receives, from antenna 305, an incoming RF signal transmitted by a base station of a wireless communication network. RF transceiver 310 down-converts the incoming RF signal to produce an intermediate frequency (IF) or a baseband signal. The IF or baseband signal is sent to RX processing circuitry 325 that produces a processed baseband signal by filtering, decoding, and/or digitizing the baseband or IF signal to produce a processed baseband signal. RX processing circuitry 325 transmits the processed baseband signal to speaker 330 (i.e., voice data) or to main controller 340 for further processing (i.e., web browsing).

TX processing circuitry 315 receives analog or digital voice data from microphone 320 or other outgoing baseband data (i.e., web data, e-mail, interactive video game data) from main controller 340. TX processing circuitry 315 encodes, multiplexes, and/or digitizes the outgoing baseband data to produce a processed baseband or IF signal.

RF transceiver 310 receives the outgoing processed baseband or IF signal from TX processing circuitry 315. RF transceiver 310 up converts the baseband or IF signal to an RF signal that is transmitted via antenna 305.

Main controller 340, in an advantageous embodiment of the present invention, is a microprocessor or a microcontroller. Main controller 340 executes basic operating system (OS) program 371 in order to control the overall operation of wireless mobile station 111. In one such operation, main controller 340 controls the reception of forward channel signals and the transmission of reverse channel signals by RF transceiver 310, RX processing circuitry 325, and TX processing circuitry 315, in accordance with well known principles.

Main controller 340 is capable of executing other processes and software applications that are resident in memory 370. Main controller 340 is capable of moving data into or out of memory 370, as may required to execute a software application.

Main controller 340 is also coupled to I/O interface 345. I/O interface 345 provides mobile station 111 with the ability to connect to other devices such as laptop computers and handheld computers. I/O interface 345 is the communication path between these accessories and main controller 340.

Main controller 340 is also coupled to keypad 350 and display unit 355. Keypad 350 is used by the end user of the mobile station to enter data into the mobile station. Display 355, in one advantageous embodiment, is a liquid crystal display capable of rendering text and/or at least limited graphics from Web sites. Alternate embodiments use other types of displays.

Memory 370 is coupled to main controller 340. Memory 370 may be comprised of solid state memory such as random access memory (RAM), various types of read only memory (ROM), or Flash RAM. Memory 370 may also include other types of memory such as micro hard drives or removable media that stores data.

Memory 370 also stores replacement data packet acquisition application 372. As will be more fully described, replacement data packet acquisition application 372 enables mobile station 111 to receive replacement data packets from base station 101 after mobile station 111 has determined (1) that it has failed to receive data packets that it was supposed to receive, or (2) that some of the data packets that it did receive contain errors.

Memory 370 also stores replacement data packet integration application 373. As will be more fully described, replacement data packet integration application 373 enables mobile station 111 to integrate replacement data packets into their appropriate position within a data packet stream to replace missing or error data packets.

Main controller 340, replacement data packet acquisition application 372, and replacement data packet integration application 373 together comprise a replacement data packet controller that is capable of carrying out the present invention.

In real time (or “streaming”) data applications (such as streaming audio or streaming video) the data packets of a data packet stream are immediately presented to the end user as they arrive. There is no time available to request and receive a transmission of replacement data packets. In such circumstances mobile station 111 must decode and play the data packet stream (audio or video) in real time. If there are missing or error data packets in the data packet stream the quality of the audio or video will be degraded.

The present invention avoids this problem by providing a system and method in which the incoming data packet stream is buffered for a period of time in main controller 340. In this manner main controller 340 assembles each incoming data packet into a data packet stream before playing the audio or video data packet stream for the end user. During the time that the data packet stream is buffered, main controller 340 acquires the replacement data packets and integrates them into the data packet stream in their appropriate positions. The present invention provides a system and method for sending the replacement data packets from base station 101 to mobile station 111 sufficiently quickly so that the replacement data packets may be integrated into the data packet stream before the data packet stream is ready for presentation to the end user.

The present invention provides a system and method for obtaining the replacement data packets using additional bandwidth for a limited period of time. Mobile station 111 obtains the replacement data packets in parallel as the incoming data packet stream continues to be received. There is no need for base station 101 to re-transmit the replacement data packets serially as some prior art systems do.

The present invention makes use of a supplemental channel (SCH) that is provided as a high speed data pipe in a 3G type system. As described in the IS-2000 standard, a supplemental channel is capable of data transmission rates of up to one hundred fifty three and six tenths kilobits per second (153.6 kbps). By comparison a fundamental channel operates at a data transmission rate of either nine and six tenths kilobits per second (9.6 kbps) or fourteen and four tenths kilobits per second (14.4 kbps).

The following examples illustrate the principles of operation of the system and method of the present invention.

### EXAMPLE ONE

Assume that base station 101 is sending data packets to mobile station 111 on a supplemental channel at the rate of seventy two kilobits per second (72 kbps). Further assume that mobile station 111 determines that it has failed to receive some of the data packets or that there are errors in some of the received data packets. Mobile station 111 then sends to base station 101 a negative acknowledgment signal (a NACK signal) for the data packets.

In response base station 101 sends replacement data packets (along with the continuing data packet stream) at an increased data transmission rate of one hundred fifty three and sixth tenths kilobits per second (153.6 kbps). In mobile station 111 main controller 340 acquires the replacement data packets using replacement data packet acquisition application 372. After main controller 340 has acquired the replacement data packets, main controller 340 sends an acknowledgment signal (an ACK signal) to base station 101. In response base station 101 decreases the data transmission rate down to the previous level of seventy two kilobits per second (72 kbps). Main controller 340 uses replacement data packet integration application 373 to incorporate the replacement data packets into their appropriate positions within the buffered data packet stream. The corrected data packet stream is then presented to the end user. The process described above may be repeated as necessary.

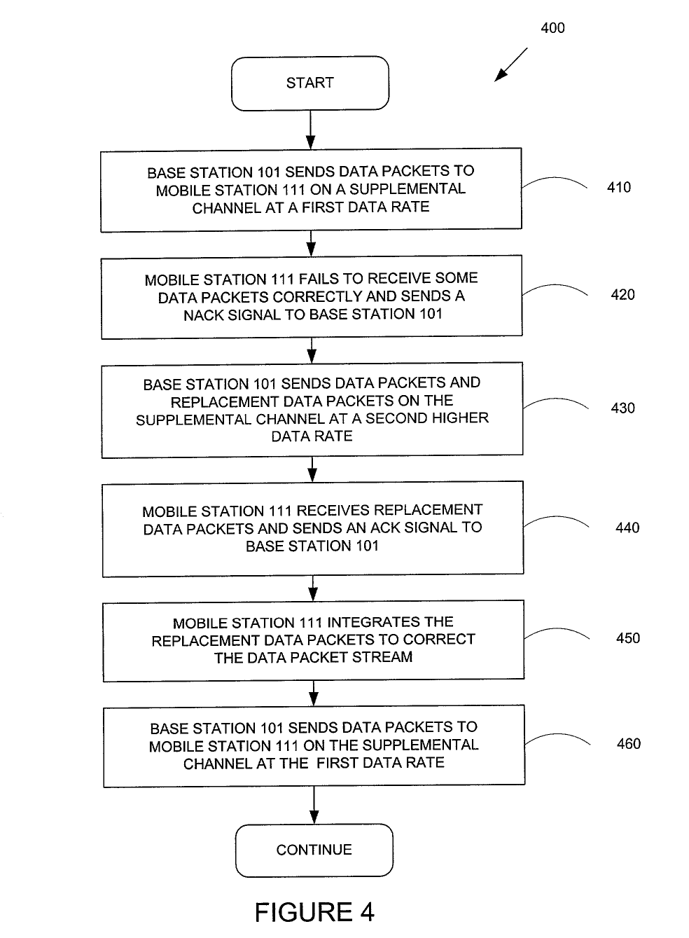

Example One represents the operation of a first advantageous embodiment of the method of the present invention. FIG. 4 illustrates a flow chart 400 showing a summary of the steps of this first advantageous embodiment of the method of the present invention. Base station 101 sends data packets to mobile station 111 on a supplemental channel at a first data rate (step 410). Mobile station 111 fails to receive some of the data packets correctly and sends a NACK signal to base station 101 (step 420). In response to receiving the NACK signal, base station 101 sends replacement data packets (within the data packet stream that base station 101 continues to transmit) to mobile station 111 on the supplemental channel at a second data rate that is higher than the first data rate (step 430).

Mobile station 111 receives the replacement data packets in main controller 340 using replacement data packet acquisition application 372 and sends an ACK signal to base station 101 (step 440). Main controller 340 in mobile station 111 uses replacement data packet integration application 373 to insert the replacement data packets into their appropriate positions within the buffered data packet stream in main controller 340 and presents the corrected data packet stream to the end user (step 450). In response to receiving the ACK signal from mobile station 111, base station 101 stops sending data packets on the supplemental channel at the second (higher) data rate and resumes sending data packets on the supplemental channel at the first (lower) data rate (step 460).

### EXAMPLE TWO

Assume that base station 101 is sending data packets to mobile station 111 on a fundamental channel at the rate of fourteen and four tenths kilobits per second (14.4 kbps). Further assume that mobile station 111 determines that it has failed to receive some of the data packets or that there are errors in some of the received data packets. Mobile station 111 then sends to base station 101 a negative acknowledgment signal (a NACK signal) for the data packets.

In response base station 101 sends replacement data packets on the supplemental channel at a data transmission rate of seventy two kilobits per second (72 kbps). In mobile station 111 main controller 340 acquires the replacement data packets using replacement data packet acquisition application 372. After main controller 340 has acquired the replacement data packets, main controller 340 sends an acknowledgment signal (an ACK signal) to base station 101. In response base station 101 ceases sending the replacement data packets on the supplemental channel. Main controller 340 uses replacement data packet integration application 373 to incorporate the replacement data packets from the supplemental channel into their appropriate positions within the buffered data packet stream. The corrected data packet stream is then presented to the end user. The process described above may be repeated as necessary.

In the embodiment of the present invention represented by Example Two main controller 340 begins to monitor the supplemental channel as soon as main controller 340 has sent the NACK signal to base station 101. After the NACK signal has been sent, main controller 340 expects to receive the replacement data packets over the supplemental channel. In an alternate embodiment, main controller 340 may continuously monitor the supplemental channel to look for incoming replacement data packets.

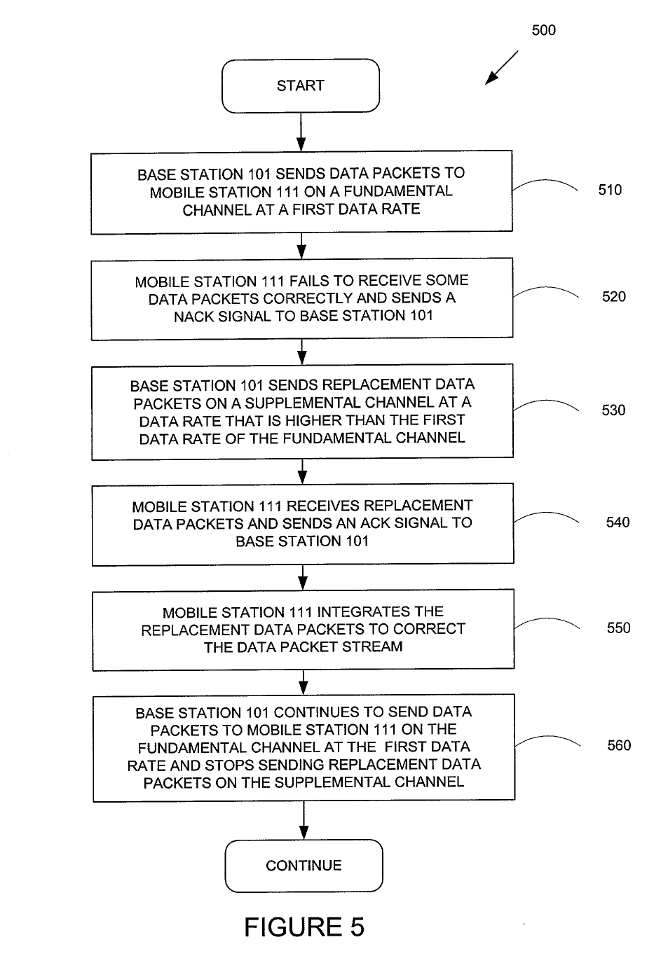

Example Two represents the operation of a second advantageous embodiment of the method of the present invention. FIG. 5 illustrates a flow chart 500 showing a summary of the steps of this second advantageous embodiment of the method of the present invention. Base station 101 sends data packets to mobile station 111 on a fundamental channel at a first data rate (step 510). Mobile station 111 fails to receive some of the data packets correctly and sends a NACK signal to base station 101 (step 520). In response to receiving the NACK signal, base station 101 sends replacement data packets to mobile station 111 on a supplemental channel at a second data rate that is higher than the first data rate (step 530).

Mobile station 111 receives the replacement data packets in main controller 340 using replacement data packet acquisition application 372 and sends an ACK signal to base station 101 (step 540). Main controller 340 in mobile station 111 uses replacement data packet integration application 373 to insert the replacement data packets into their appropriate positions within the buffered data packet stream in main controller 340 and presents the corrected data packet stream to the end user (step 550). In response to receiving the ACK signal from mobile station 111, base station 101 stops sending the replacement data packets on the supplemental channel and continues sending data packets on the fundamental channel at the first data rate (step 560).

Example One and Example Two set forth above are illustrative examples only. That is, the present invention is not limited to Example One and Example Two set forth above. Other examples of embodiments of the present invention may be devised that incorporate the principles of the present invention.

It is noted that the system and method of the present invention is capable of replacing data packets for reasonably small amounts of lost data. In a typical fading environment a fade may last for ten milliseconds (10 ms) or twenty milliseconds (20 ms) and then a good channel connection is re-established. In such circumstances the system and method of the present invention is capable of providing replacement data packets for the missing or error data packets. If a fade lasts for a sufficiently long period of time, the system and method of the present invention will not be able to provide replacement data packets.

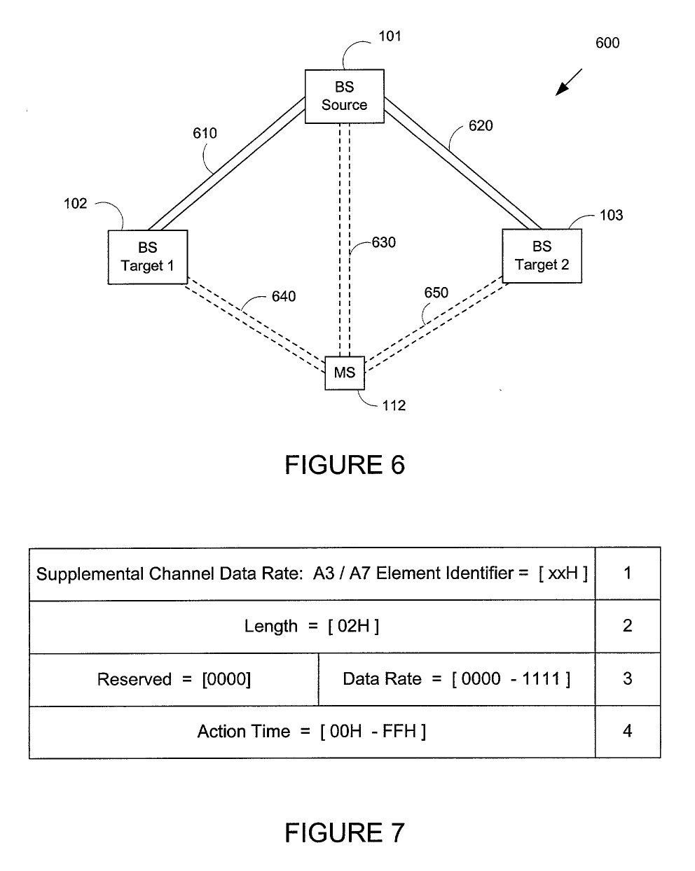

FIG. 6 illustrates an exemplary handoff 600 of wireless mobile station 112 according to an advantageous embodiment of the present invention. As shown in FIG. 1, mobile station 112 is motion away from base station 101. Base station 101 is the source base station that is handing off mobile station 112 to a target base station. The exemplary configuration shown in FIG. 6 comprises target base station 102 (Target 1) and target base station 103 (Target 2). Link 610 between base station 101 and base station 102 comprises an A3 link as described in the IS-2000 standard. Link 620 between base station 101 and base station 103 is also an A3 link. The A3 links are shown with solid lines.

Mobile station 112 is in communication with base station 101 through air link 630. In a soft handoff, mobile station 112 is also in communication with base station 102 through air link 640 and with base station 103 through air link 650. The air links are shown with dotted lines. Mobile station 112 is receiving signaling messages from base station 101, base station 102, and base station 103 on a Dedicated Control Channel (DCCH).

Base station 101 receives data packets to be delivered to mobile station 112. Base station 101 receives power strength measurements from mobile station 112 and uses the power strength measurements to decide that base station 103 (Target 2) would be the best target base station on which to send the burst of data packets to mobile station 112. Base station 101 schedules the burst of data packets to be sent from base station 103 using signaling methods described in the IS-2000 standard. Base station 101 then sends an ESCAM message to mobile station 112 over the Dedicated Control Channel (DCCH) scheduling the burst of data packets.

At the scheduled time mobile station 112 begins to receive the data packets on the supplemental channel (SCH) through link 620 and link 650. The data packets are sent as a data rate that is less than the maximum allowable rate for the supplemental channel (SCH). For example, assume that the data packets are sent at a data rate of seventy two kilobits per second (72 kbps). At some point during the transmission of the burst of data packets, mobile station 112 enters a fade and some data packets are lost. When mobile station 112 emerges from the fade, mobile station 112 sends a negative acknowledgment signal (a NACK signal) to base station 101. Note that if the fade does not cause the link through the Dedicated Control Channel (DCCH) to be broken, it is possible that base station 101 may obtain information through the Dedicated Control Channel (DCCH) reporting the existence of the fade of the supplemental channel (SCH) even before mobile station 112 emerges from the fade.

Base station 101 then sends a physical transition directive message (described more fully below) to base station 103 that base station 101 intends to increase the bandwidth of the supplemental channel (SCH) through link 620 and link 650. If base station 103 is able to increase the bandwidth of the supplemental channel, base station 101 sends an ESCAM message to mobile station 112 on the Dedicated Control Channel (DCCH) that the bandwidth on the supplemental channel (SCH) will be increased.

In an alternate advantageous embodiment of the present invention, base station 101 may cause a second supplemental channel to be activated. In this alternate advantageous embodiment, base station 101 sends an IS-2000 message to base station 103 that base station 101 intends to activate a second supplemental channel (SCH) through link 620 and link 650. If base station 103 is able to activate the second supplemental channel, base station 101 sends an ESCAM message to mobile station 112 on the Dedicated Control Channel (DCCH) that the second supplemental channel (SCH) will be activated.

After the bandwidth on the supplemental channel (SCH) has been increased (or the second supplemental channel (SCH) has been activated), base station 101 sends (1) data packets that would normally be sent, and (2) replacement data packets for the data packets that were lost during the fade. The normal data packets and the replacement data packets are sent from base station 101 through link 620 to base station 103 and through link 650 to mobile station 112.

The normal data packets and the replacement data packets are sent at a data rate that is greater than the first data rate of the supplemental channel (SCH). For example, if the first data rate of the supplemental channel was seventy two kilobits per second (72 kbps), the increased data rate may be one hundred fifty three and sixth tenths kilobits per second (153.6 kbps). The replacement data packets are received and inserted into their appropriate locations in the data packet stream in the manner previously described.

After the replacement data packets have been successfully received, mobile station 112 sends an acknowledgment signal (an ACK signal) to base station 101 on the Dedicated Control Channel (DCCH). Base station 101 then sends a physical transition directive message (described more fully below) to base station 103 that base station 101 intends to decrease the bandwidth of the supplemental channel (SCH). Alternatively, base station 101 sends an IS-2000 message to base station 103 to deactivate the second supplemental channel. Base station 101 then sends an ESCAM message to mobile station 112 that the bandwidth of the supplemental channel (SCH) will be decreased (or, alternatively, that the second supplemental channel will be deactivated). The supplemental channel then returns to its original first data rate (e.g., seventy two kilobits per second (72 kbps)) for the remainder of the burst of the data packets.

FIG. 7 illustrates a format for a physical transition directive message of the present invention. Lines 1 through 4 comprise additional information added to a previously existing A3 physical transition directive message. An A3 physical transition directive message is transmitted over a link between a source base station (e.g., base station 101) and a target base station (e.g. base station 103). The physical transition directive message of the present invention comprises a previously existing A3 physical transition directive message plus the information set forth in Lines 1 through 4 shown in FIG. 7.

Line 1 sets forth and contains an A3/A7 element identifier. This information will be in the form of a hexadecimal number and will be assigned by the standards editor. The letter “H” stands for hexadecimal notation. Line 2 describes the length of the data that will follow. The length of the data will be two bytes. The length will be 02H. The left half of Line 3 is reserved for future use. The right half of Line 3 is the data rate. The data rate is the requested (or granted) data rate for the supplemental channel (SCH) associated with the A3 link that the message is sent on. The data rate is coded in the same manner as the Forward Burst Radio Info element in the IS-2000 standard. Line 4 contains the action time. The action time states the time that the new data rate is to take effect. The action time is a hexadecimal number and is coded in the same manner as the Reverse Pilot Gating Rate element is coded in the IS-2000 standard.

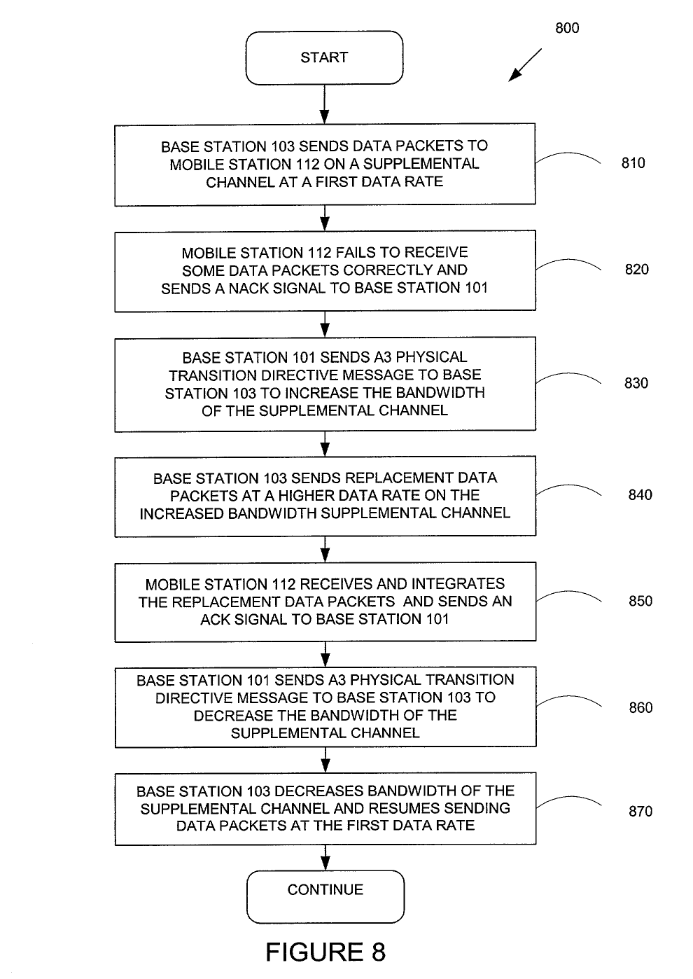

FIG. 8 illustrates a flow chart 800 showing the steps of an exemplary handoff of wireless mobile station 112 according to an advantageous embodiment of the method of the present invention. As previously described base station 101 is the source base station and base station 103 is the target base station selected by source base station 101. Base station receives data packets from base station 101 and sends the data packets to mobile station 112 on a supplemental channel at a first data rate (step 810). When mobile station 112 enters a fade it loses some of the data packets. Mobile station 112 then sends a negative acknowledgment signal (a NACK signal) to base station 101 on the Dedicated Control Channel (DCCH) (step 820).

Base station 101 then sends an A3 physical transition directive message to base station 103 to increase the bandwidth of the supplemental channel (step 830). In an alternative embodiment, base station 101 sends an IS-2001 message to base station 103 to add and activate a second supplemental channel (step not shown). After the bandwidth of the supplemental channel has been increased, base station 103 sends the replacement data packets (together with the normally scheduled data packets) at a higher data rate on the increased bandwidth supplemental channel (step 840). Mobile station 112 receives and integrates the replacement data packets. Mobile station 112 then sends an acknowledgment signal (an ACK signal) to base station 101 (step 850).

Base station 101 then sends an A3 physical transition directive message to base station 103 to decrease the bandwidth of the supplemental channel (step 860). In an alternative embodiment, base station 101 sends an IS-2001 message to base station 103 to deactivate the second supplemental channel (step not shown). Base station 103 then decreases the bandwidth of the supplemental channel and resumes sending data packets on the supplemental channel on the first data rate (step 870).

The present invention significantly improves the performance of wireless data packet communications systems in several ways. The present invention reduces the time required for the transmission of data packets in a communication channel that experiences fading. The present invention also improves the reliability of the communication of time sensitive information transmitted by data packets. The present invention also provides efficient use of available bandwidth in a multi-channel system. The present invention reduces the transmit power required by transmitters to produce a reliable transmission of data. The present invention also reduces the amount of battery power required in mobile stations in a mobile wireless communication system. The present invention increases the ability of the wireless communication system to provide a high level of quality of service. The present invention also increases the efficiency of spectrum utilization in code division multiple access (CDMA) systems.

Although the present invention has been described in detail, those skilled in the art should understand that they can make various changes, substitutions and alterations herein without departing from the spirit and scope of the invention in its broadest form.

What is claimed is:

1. For use in a wireless network communications system comprising at least one base station and at least one mobile station, an apparatus for increasing a data transmission rate in a mobile wireless communication channel, said apparatus comprising:
a base station that is capable of sending data packets to a mobile station on a supplemental channel at a first data rate, and capable of receiving a negative acknowledgment signal from said mobile station that said mobile station failed to correctly receive at least one data packet, and capable of sending at least one replacement data packet to said mobile station on said supplemental channel at a second higher data rate; and
a mobile station comprising a replacement data packet controller capable of receiving said at least one replacement data packet from said base station and incorporating said at least one replacement data packet into a data packet stream to replace one of: a missing data packet and an error data packet.

2. The apparatus as set forth in claim 1 wherein said mobile station is further capable of sending an acknowledgment signal to said base station that said mobile station has received said at least one replacement data packet from said base station and wherein in response to receiving said acknowledgment signal said base station is further capable of ceasing sending said at least one replacement data packet on said supplemental channel at said second higher data rate, and is further capable of sending data packets to said mobile station on said supplemental channel at said first data rate.

3. The apparatus as set forth in claim 1 wherein said replacement data packet controller of said mobile station comprises:
a main controller;
a replacement data packet acquisition application executable by said main controller, said replacement data packet acquisition application capable of acquiring at least one replacement data packet from said base station; and
a replacement data packet integration application executable by said main controller, said replacement data packet integration application capable of integrating said at least one replacement data packet from said base station into a data packet stream to replace one of: a missing data packet and an error data packet.

4. The apparatus as set forth in claim 2 wherein said first data rate on said supplemental channel is seventy two kilobits per second and wherein said second higher data rate on said supplemental channel is greater than seventy two kilobits per second.

5. For use in a wireless network communications system comprising at least one base station and at least one mobile station, an apparatus for increasing a data transmission rate in a mobile wireless communication channel, said apparatus comprising:
a base station that is capable of sending data packets to a mobile station on a fundamental channel at a first data rate, and capable of receiving a negative acknowledgment signal from said mobile station that said mobile station failed to correctly receive at least one data packet, and capable of sending at least one replacement data packet to said mobile station on a supplemental channel at a second higher data rate; and
a mobile station comprising a replacement data packet controller capable of receiving said at least one replacement data packet from said base station and incorporating said at least one replacement data packet into a data packet stream to replace one of: a missing data packet and an error data packet.

6. The apparatus as set forth in claim 5 wherein said mobile station is further capable of sending an acknowledgment signal to said base station that said mobile station has received said at least one replacement data packet from said base station and wherein in response to receiving said acknowledgment signal said base station is further capable of ceasing sending said at least one replacement data packet on said supplemental channel at said second higher data rate, and is further capable of sending data packets to said mobile station on said fundamental channel at said first data rate.

7. The apparatus as set forth in claim 5 wherein said replacement data packet controller of said mobile station comprises:
a main controller;
a replacement data packet acquisition application executable by said main controller, said replacement data packet acquisition application capable of acquiring at least one replacement data packet from said base station; and
a replacement data packet integration application executable by said main controller, said replacement data packet integration application capable of integrating said at least one replacement data packet from said base station into a data packet stream to replace one of: a missing data packet and an error data packet.

8. The apparatus as set forth in claim 6 wherein said first data rate on said fundamental channel is fourteen and one tenths kilobits per second and wherein said second higher data rate on said supplemental channel is greater than fourteen and one tenths kilobits per second.

9. For use in a wireless network communications system comprising a plurality of base stations and at least one mobile station, an apparatus for increasing a data transmission rate in a mobile wireless communication channel when a first base station is handing off to a second base station a transmission of data packets for a mobile station, said apparatus comprising:
a first base station that is capable of sending data packets to a second base station on a supplemental channel at a first data rate;
wherein second base station is capable of sending said data packets to said mobile station on said supplemental channel at said first data rate;
wherein said first base station is capable of receiving a negative acknowledgment signal from said mobile station that said mobile station failed to correctly receive at least one data packet from said second base station;
wherein said first base station is capable of sending an A3 physical transition directive message to said second base station to cause said second base station to increase a bandwidth of said supplemental channel to said mobile station;
wherein said first base station and said second base station are capable of sending at least one replacement data packet to said mobile station on said increased bandwidth supplemental channel at a second higher data rate; and
wherein said mobile station comprises a replacement data packet controller capable of receiving said at least one replacement data packet and incorporating said at least one replacement data packet into a data packet stream to replace one of: a missing data packet and an error data packet.

10. The apparatus as set forth in claim 9 wherein said mobile station is further capable of sending an acknowledgment signal to said first base station that said mobile station has received said at least one replacement data packet;
wherein in response to receiving said acknowledgment signal from said mobile station said first base station is further capable of sending an A3 physical transition directive message to said second base station to cause said second base station to decrease said bandwidth of said supplemental channel to said mobile station;
wherein said first base station and said second base station are further capable of ceasing to send said at least one replacement data packet on said supplemental channel at said second higher data rate; and
wherein said first base station and said second base station are further capable of sending data packets to said mobile station on said supplemental channel at said first data rate.

11. The apparatus as set forth in claim 9 wherein said replacement data packet controller of said mobile station comprises:
a main controller;
a replacement data packet acquisition application executable by said main controller, said replacement data packet acquisition application capable of acquiring at least one replacement data packet from a base station; and
a replacement data packet integration application executable by said main controller, said replacement data packet integration application capable of integrating said at least one replacement data packet from said base station into a data packet stream to replace one of: a missing data packet and an error data packet.

12. The apparatus as set forth in claim 9 wherein said first base station is capable of sending an IS-2000 message to said second base station to cause said second base station to activate a second supplemental channel to said mobile station; and
wherein said first base station and said second base station are capable of sending at least one replacement data packet to said mobile station on said second supplemental channel at a second higher data rate.

13. The apparatus as set forth in claim 12 wherein said mobile station is further capable of sending an acknowledgment signal to said first base station that said mobile station has received said at least one replacement data packet;
wherein in response to receiving said acknowledgment signal from said mobile station said first base station is further capable of sending an IS-2000 message to said second base station to cause said second base station to deactivate said second supplemental channel to said mobile station;
wherein said first base station and said second base station are further capable of ceasing to send said at least one replacement data packet on said second supplemental channel at said second higher data rate; and
wherein said first base station and said second base station are further capable of sending data packets to said mobile station on a supplemental channel at said first data rate.

14. The apparatus as set forth in claim 13 wherein said A3 physical transition directive message contains information comprising one of: an element identifier, a length, a data rate, and an action time.

15. The apparatus as set forth in claim 10 wherein said first data rate on said supplemental channel is seventy two kilobits per second and wherein said second higher data rate on said increased bandwidth supplemental channel is greater than seventy two kilobits per second.

16. For use in a wireless network communications system comprising a plurality of base stations and at least one mobile station, an apparatus for increasing a data transmission rate in a mobile wireless communication channel when a first base station is handing off to a second base station a transmission of data packets for a mobile station, said apparatus comprising:
a first base station that is capable of sending data packets to a second base station on a fundamental channel at a first data rate;
wherein second base station is capable of sending said data packets to said mobile station on said fundamental channel at said first data rate;
wherein said first base station is capable of receiving a negative acknowledgment signal from said mobile station that said mobile station failed to correctly receive at least one data packet from said second base station;
wherein said first base station is capable of sending an IS-2000 message to said second base station to cause said second base station to activate a supplemental channel to said mobile station;
wherein said first base station and said second base station are capable of sending at least one replacement data packet to said mobile station on said supplemental channel at a second higher data rate; and
wherein said mobile station comprises a replacement data packet controller capable of receiving said at least one replacement data packet and incorporating said at least one replacement data packet into a data packet stream to replace one of: a missing data packet and an error data packet.

17. The apparatus as set forth in claim 16 wherein said mobile station is further capable of sending an acknowledgment signal to said first base station that said mobile station has received said at least one replacement data packet;
wherein in response to receiving said acknowledgment signal from said mobile station said first base station is further capable of sending an IS-2000 message to said second base station to cause said second base station to deactivate said supplemental channel to said mobile station;
wherein said first base station and said second base station are further capable of ceasing to send said at least one replacement data packet on said supplemental channel at said second higher data rate; and
wherein said first base station and said second base station are further capable of sending data packets to said mobile station on said fundamental channel at said first data rate.

18. The apparatus as set forth in claim 17 wherein said first data rate on said fundamental channel is fourteen and one tenths kilobits per second and wherein said second higher data rate on said supplemental channel is greater than fourteen and one tenths kilobits per second.

19. For use in a wireless network communications system comprising at least one base station and at least one mobile station, a method for increasing a data transmission rate in a mobile wireless communication channel, said method comprising the steps of:
sending data packets from a base station to a mobile station on a supplemental channel at a first data rate;
receiving in said base station a negative acknowledgment signal from said mobile station that said mobile station failed to correctly receive at least one data packet;
sending at least one replacement data packet from said base station to said mobile station on said supplemental channel at a second higher data rate;
receiving said at least one replacement data packet from said base station in a replacement data packet controller of said mobile station; and
incorporating said at least one replacement data packet into a data packet stream within said mobile station to replace one of: a missing data packet and an error data packet.

20. The method as set forth in claim 19 further comprising the steps of:
sending an acknowledgment signal from said mobile station to said base station that said mobile station has received said at least one replacement data packet from said base station;
in response to receiving said acknowledgment signal, ceasing to send from said base station said at least one replacement data packet on said supplemental channel at said second higher data rate; and
sending data packets from said base station to said mobile station on said supplemental channel at said first data rate.

21. The method as set forth in claim 19 wherein said replacement data packet controller of said mobile station comprises:
a main controller;
a replacement data packet acquisition application executable by said main controller, said replacement data packet acquisition application capable of acquiring at least one replacement data packet from said base station; and
a replacement data packet integration application executable by said main controller, said replacement data packet integration application capable of integrating said at least one replacement data packet from said base station into a data packet stream to replace one of: a missing data packet and an error data packet.

22. The method as set forth in claim 20 wherein said first data rate on said supplemental channel is seventy two kilobits per second and wherein said second higher data rate on said supplemental channel is greater than seventy two kilobits per second.

23. For use in a wireless network communications system comprising at least one base station and at least one mobile station, a method for increasing a data transmission rate in a mobile wireless communication channel, said method comprising the steps of:
sending data packets from a base station to a mobile station on a fundamental channel at a first data rate;
receiving in said base station a negative acknowledgment signal from said mobile station that said mobile station failed to correctly receive at least one data packet;
sending at least one replacement data packet from said base station to said mobile station on a supplemental channel at a second higher data rate; and
receiving said at least one replacement data packet from said base station in a replacement data packet controller of said mobile station; and
incorporating said at least one replacement data packet into a data packet stream within said mobile station to replace one of: a missing data packet and an error data packet.

24. The method as set forth in claim 23 further comprising the steps of:
sending an acknowledgment signal from said mobile station to said base station that said mobile station has received said at least one replacement data packet from said base station;
in response to receiving said acknowledgment signal, ceasing to send from said base station said at least one replacement data packet on said supplemental channel at said second higher data rate; and
sending data packets from said base station to said mobile station on said fundamental channel at said first data rate.

25. The method as set forth in claim 23 wherein said replacement data packet controller of said mobile station comprises:
a main controller;
a replacement data packet acquisition application executable by said main controller, said replacement data packet acquisition application capable of acquiring at least one replacement data packet from said base station; and
a replacement data packet integration application executable by said main controller, said replacement data packet integration application capable of integrating said at least one replacement data packet from said base station into a data packet stream to replace one of: a missing data packet and an error data packet.

26. The method as set forth in claim 24 wherein said first data rate on said fundamental channel is fourteen and one tenths kilobits per second and wherein said second higher data rate on said supplemental channel is greater than fourteen and one tenths kilobits per second.

27. For use in a wireless network communications system comprising a plurality of base stations and at least one mobile station, a method for increasing a data transmission rate in a mobile wireless communication channel when a first base station is handing off to a second base station a transmission of data packets for a mobile station, said method comprising the steps of:
sending data packets from a first base station to a second base station on a supplemental channel at a first data rate;
sending said data packets from said second base station to said mobile station on said supplemental channel at said first data rate;
receiving in said first base station a negative acknowledgment signal from said mobile station that said mobile station failed to correctly receive at least one data packet from said second base station;
sending an A3 physical transition directive message from said first base station to said second base station to cause said second base station to increase a bandwidth of said supplemental channel to said mobile station;
sending at least one replacement data packet from said first base station and said second base station to said mobile station on said increased bandwidth supplemental channel at a second higher data rate;
receiving said at least one replacement data packet in a replacement data packet controller of said mobile station; and
incorporating said at least one replacement data packet into a data packet stream within said mobile station to replace one of: a missing data packet and an error data packet.

28. The method as set forth in claim 27 further comprising the steps of:
sending an acknowledgment signal from said mobile station to said first base station that said mobile station has received said at least one replacement data packet;
in response to receiving said acknowledgment signal from said mobile station, sending an A3 physical transition directive message from said first base station to said second base station to cause said second base station to decrease said bandwidth of said supplemental channel to said mobile station;
ceasing to send from said first base station and said second base station said at least one replacement data packet on said supplemental channel at said second higher data rate; and
sending data packets from said first base station and said second base station to said mobile station on said supplemental channel at said first data rate.

29. The method as set forth in claim 27 wherein said replacement data packet controller of said mobile station comprises:
a main controller;
a replacement data packet acquisition application executable by said main controller, said replacement data packet acquisition application capable of acquiring at least one replacement data packet from a base station; and
a replacement data packet integration application executable by said main controller, said replacement data packet integration application capable of integrating said at least one replacement data packet from said base station into a data packet stream to replace one of: a missing data packet and an error data packet.

30. The method as set forth in claim 27 further comprising the steps of:
sending an IS-2000 message from said first base station to said second base station to cause said second base station to activate a second supplemental channel to said mobile station; and
sending at least one replacement data packet from said first base station and said second base station to said mobile station on said second supplemental channel at a second higher data rate.

31. The method as set forth in claim 30 further comprising the steps of:
sending an acknowledgment signal from said mobile station to said first base station that said mobile station has received said at least one replacement data packet;
in response to receiving said acknowledgment signal from said mobile station, sending an IS-2000 message from said first base station to said second base station to cause said second base station to deactivate said second supplemental channel to said mobile station;
ceasing to send said at least one replacement data packet from said first base station and said second base station on said second supplemental channel at said second higher data rate; and
sending data packets from said first base station and said second base station to said mobile station on a supplemental channel at said first data rate.

32. The method as set forth in claim 31 wherein said A3 physical transition directive message contains information comprising one of: an element identifier, a length, a data rate, and an action time.

33. The method as set forth in claim 28 wherein said first data rate on said supplemental channel is seventy two kilobits per second and wherein said second higher data rate on said increased bandwidth supplemental channel is greater than seventy two kilobits per second.

34. For use in a wireless network communications system comprising a plurality of base stations and at least one mobile station, a method for increasing a data transmission rate in a mobile wireless communication channel when a first base station is handing off to a second base station a transmission of data packets for a mobile station, said method comprising the steps of:
sending data packets from a first base station to a second base station on a fundamental channel at a first data rate;
sending said data packets from said second base station to said mobile station on said fundamental channel at said first data rate;
receiving in said first base station a negative acknowledgment signal from said mobile station that said mobile station failed to correctly receive at least one data packet from said second base station;
sending an IS-2000 message from said first base station to said second base station to cause said second base station to activate a supplemental channel to said mobile station;
sending at least one replacement data packet from said first base station and said second base station to said mobile station on said supplemental channel at a second higher data rate; and
receiving said at least one replacement data packet in a replacement data packet controller of said mobile station; and
incorporating said at least one replacement data packet into a data packet stream within said mobile station to replace one of: a missing data packet and an error data packet.

35. The method as set forth in claim 34 further comprising the steps of:
sending an acknowledgment signal from said mobile station to said first base station that said mobile station has received said at least one replacement data packet;
in response to receiving said acknowledgment signal from said mobile station, sending an IS-2000 message from said first base station to said second base station to cause said second base station to deactivate said supplemental channel to said mobile station;
ceasing to send from said first base station and said second base station said at least one replacement data packet on said supplemental channel at said second higher data rate; and
sending data packets from said first base station and said second base station to said mobile station on said fundamental channel at said first data rate.

36. The method as set forth in claim 35 wherein said first data rate on said fundamental channel is fourteen and one tenths kilobits per second and wherein said second higher data rate on said supplemental channel is greater than fourteen and one tenths kilobits per second.
